(19) United States
(12) Patent Application Publication
(10) Pub. No.: US 2017/0287014 A1
(43) Pub. Date: Oct. 5, 2017

(54) Automated Direct Response Advertising Server

(71) Applicants: Hung D. Vu, Irvine, CA (US); Peter Nguyen, Villa Park, CA (US); Jay D. Bose, Irvine, CA (US); Tom Furukawa, Rancho Santa Margarita, CA (US); Andrew Puchalski, Venice, CA (US); Justin Durham, Pasadena, MD (US); James Durham, Herndon, VA (US); Daniel Eichler, Huntington Beach, CA (US); James Nguyen, Placentia, CA (US); Matthew P.H. Kam, Torrance, CA (US); Kayvan Fayazkhah, Irvine, CA (US); Brendan Paul, Santa Ana, CA (US); Dong Derek Nguyen, Fountain Valley, CA (US)

(72) Inventors: Hung D. Vu, Irvine, CA (US); Peter Nguyen, Villa Park, CA (US); Jay D. Bose, Irvine, CA (US); Tom Furukawa, Rancho Santa Margarita, CA (US); Andrew Puchalski, Venice, CA (US); Justin Durham, Pasadena, MD (US); James Durham, Herndon, VA (US); Daniel Eichler, Huntington Beach, CA (US); James Nguyen, Placentia, CA (US); Matthew P.H. Kam, Torrance, CA (US); Kayvan Fayazkhah, Irvine, CA (US); Brendan Paul, Santa Ana, CA (US); Dong Derek Nguyen, Fountain Valley, CA (US)

(21) Appl. No.: 15/477,086

(22) Filed: Apr. 1, 2017

Related U.S. Application Data
(60) Provisional application No. 62/317,274, filed on Apr. 1, 2016.

(51) Int. Cl. G06Q 30/02; H04L 29/06

(52) U.S. Cl. CPC G06Q 30/0269; H04L 63/1416

(57) ABSTRACT

An automated direct response advertising system can include: collecting information of a consumer; routing and matching the consumer to an offer of a product; providing content to the consumer with a reusable page, reusable page components, reusable multi-tenant components, and white-labeling components; requesting contact information from the consumer; requesting billing information from the consumer; providing a cross-sell offer for complimentary products of the product; providing an up-sell offer for upgrades to the product; aggregating information within an advanced analytics module; and displaying the information from the advanced analytics module on a display.

### CROSS-REFERENCE TO RELATED APPLICATIONS

This claims priority benefit to all common subject matter of U.S. Provisional Patent Application 62/317,274 filed Apr. 1, 2016. The content of this application is incorporated herein by reference in its entirety.

### TECHNICAL FIELD

This disclosure relates to a direct response advertising system, and more particularly to software-as-a-service advertising platforms.

### BACKGROUND

Direct response advertisements are used by a variety of businesses as a cost effective alternative to brand recognition campaigns. Direct response advertisements can be targeted at the segment of the consuming population most likely to have an interest in the advertised product. Direct response advertisements further have the advantage of requiring an immediate action from the consumer.

Examples of actions required from the consumer include the provision of contact information and/or the provision of credit card or other payment information. Although direct response advertising services are beneficial to a variety of businesses, existing direct response advertising services have a number of drawbacks.

For example, many existing direct response advertising services require the advertiser to orchestrate different departments or 3rd party services to produce effective offer designs then host the offers digitally on complicated information technology infrastructures. In addition, existing direct response advertising services require multi-level decision making within the advertising company.

For example, existing direct response advertising services require analysis of conversion rates for different advertisements, and require manual management of caps/sell-able inventory for each offer being advertised. Such decisions require the input of product managers, creative departments, and IT departments, and can therefore result in delays, added expense, and lost sales.

Solutions have been long sought but prior developments have not taught or suggested any complete solutions, and solutions to these problems have long eluded those skilled in the art. Thus there remains a considerable need for devices and methods that can reduce delays, expense, and required expertise in digital offers.

### SUMMARY

An automated direct response advertising system providing significantly reduced costs, faster or near immediate response times, and requiring less expertise, are disclosed. The advertising system and methods can include: collecting information of a consumer including information of an affiliate source of the consumer, demographics of the consumer, date and time of engagement by the consumer, information of a device used by the consumer, an IP address for the consumer, and geolocation of the consumer; routing and matching the consumer to an offer of a product based conversion rates, post-sale consumer events, customer lifetime value scores, demographics, offer ratings, affiliate ratings, traffic ratings page designs, spit-test results, payment gateways, targets, goals, constraints, available caps to sellable units, blacklists, gray lists, and whitelists; providing content to the consumer with a reusable page, reusable page components, reusable multi-tenant components, and white-labeling components; requesting contact information from the consumer; requesting billing information from the consumer; providing a cross-sell offer for complimentary products of the product; providing an up-sell offer for upgrades to the product; aggregating information including: a conversion rate, a take rate, prices, a subscription rate, a re-bill rate, a cancellation rate, a refund rate, design template performance, offer performance, affiliate performance, traffic source performance, blacklists, gray lists, and whitelists within an advanced analytics module; and displaying the information from the advanced analytics module on a display.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The advertising system is illustrated in the figures of the accompanying drawings which are meant to be exemplary and not limiting, in which like reference numerals are intended to refer to like components, and in which:

FIG. 1 is a block diagram of an embodiment of the advertising system.

FIG. 2 is a control flow for the SMART-funnel of FIG. 1.

FIG. 3 is a graphical display of an affiliate display of the advertising system of FIG. 1.

FIG. 4 is a graphical display of an advertiser display of the advertising system of FIG. 1.

FIG. 5 is a control flow of business to consumer management for the advertising system of FIG. 1.

FIG. 6 is a control flow of business intelligence for the advertising system of FIG. 1.

FIG. 7 is a control flow of feedback for the advertising system of FIG. 1.

FIG. 8 is a control flow of customer feedback for the advertising system of FIG. 1.

FIG. 9 is a control flow for the advertiser portal of FIG. 6.

FIG. 10 is a control flow for the affiliate portal of FIG. 6.

FIG. 11 is a block diagram for a distributed system for the advertising system of FIG. 1.

### DETAILED DESCRIPTION

In the following description, reference is made to the accompanying drawings that form a part hereof, and in which are shown by way of illustration, embodiments in which the advertising system may be practiced. It is to be understood that other embodiments may be utilized and structural changes may be made without departing from the scope of the advertising system.

When features, aspects, or embodiments of the advertising system are described in terms of steps of a process, an operation, a control flow, or a flow chart, it is to be understood that the steps can be combined, performed in a different order, deleted, or include additional steps without departing from the advertising system as described herein.

The advertising system is described in sufficient detail to enable those skilled in the art to make and use the advertising system and provide numerous specific details to give a thorough understanding of the advertising system; however, it will be apparent that the advertising system may be practiced without these specific details.

In order to avoid obscuring the advertising system, some well-known system configurations, formulae, processing techniques, and algorithms are not disclosed in detail. Likewise, the drawings showing embodiments of the system are semi-diagrammatic and not to scale and, particularly, some of the dimensions are for the clarity of presentation and are shown greatly exaggerated in the drawing FIGs. As used herein, the term system is defined as a device or method depending on the context in which it is used.

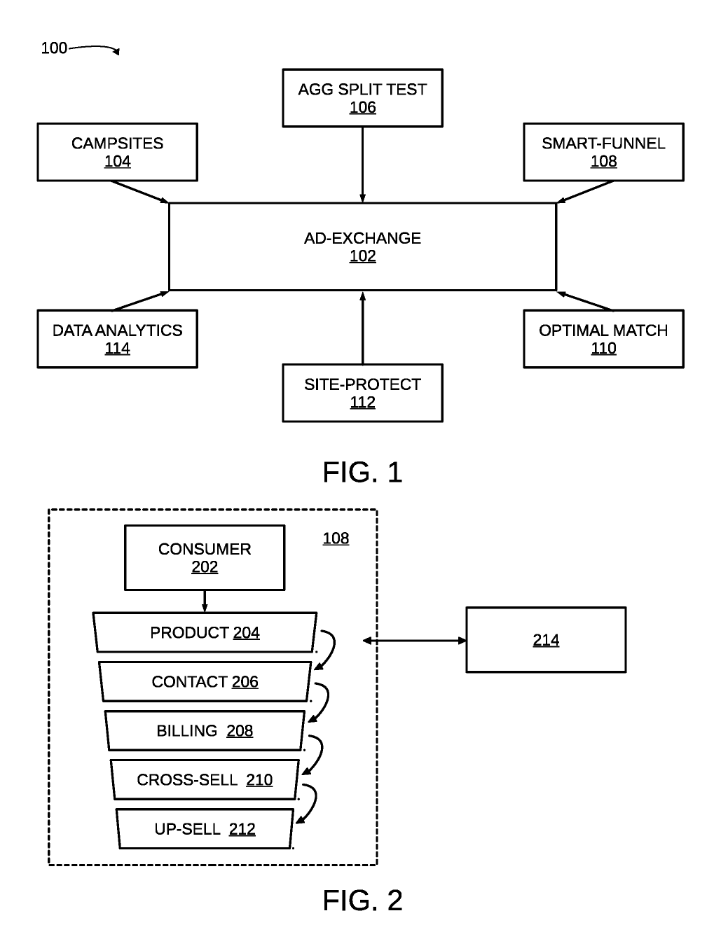

Referring now to FIG. 1, therein is shown a block diagram of an embodiment of the advertising system 100. The advertising system 100 can be shown including an ad-exchange 102.

The ad-exchange 102 can be implemented on an advertising server. The ad-exchange 102 can include CAMPsites 104. The CAMPsites 104 can be white-labeled, template driven and customizable offer pages.

The offer pages can be product pages, payment pages, up-sell pages, and other pages. It has been discovered that the template driven nature of the offer pages of the CAMPsites 104 can be created in a matter of minutes drastically reducing the time and cost requirements for creating and delivering the CAMPsites 104.

The ad-exchange 102 can further include aggregate split testing 106. The aggregate split testing 106 can be controlled and randomized experiments. The aggregate split testing 106 can provide improved website metrics including clicks, purchases, or information collections.

The aggregate split testing 106 can be continuous multi-campaign split-testing, which can provide metrics over multiple advertising campaigns. It has been discovered that the aggregate split testing 106 can reach statistical significance faster than previous solutions.

The ad-exchange 102 can further include SMART-funnels 108. The SMART-funnels 108 can automatically direct internet or user traffic across multiple offers of multiple advertising campaigns or multiple offers of a single advertising campaign. It has been discovered that the SMART-funnels 108 can provide a maximization of the performance of the offers and can obtain higher fill rates of the users within the ad-exchange 102 meaning the user interaction in filling out forms, completing transactions, and even user clicks within advertising campaigns can be increased and maximized.

The ad-exchange 102 can further include optimal matching 110. The optimal matching 110 can identify and match the highest performing advertising campaigns with qualified user traffic sources. It is contemplated that qualified user traffic sources can be traffic sources from particular websites, particular geographical areas, or can be users that have been categorized within a specific socioeconomic group.

The ad-exchange 102 further includes SITE-protect 112. The SITE-protect 112 can monitor advertising campaign traffic for malicious indicators. The SITE-protect 112 can block malicious traffic in real-time. Malicious indicators can be indicia of fraud or malware.

The ad-exchange 102 further includes data analytics 114. The data analytics 114 can provide or be implemented as real-time continuous monitoring and reporting of advertising campaign key performance indicators.

Key performance indicators can be measurable data related to how effective the advertising campaigns are. The key performance indicators can include new customer acquisition, demographic analysis, customer attrition, profitability of customers, collection of contact information, collection of billing information, customer cross-sells, and customer up-sells. The data analytics 114 can further provide or be implemented as real-time continuous monitoring and collection of business intelligence.

It is contemplated that the ad-exchange 102 can be implemented in many areas including selling shippable and non-shippable products like as e-books. The ad-exchange 102 can further be implemented to straight sell products, subscriptions, trial memberships, and lead-generation product types.

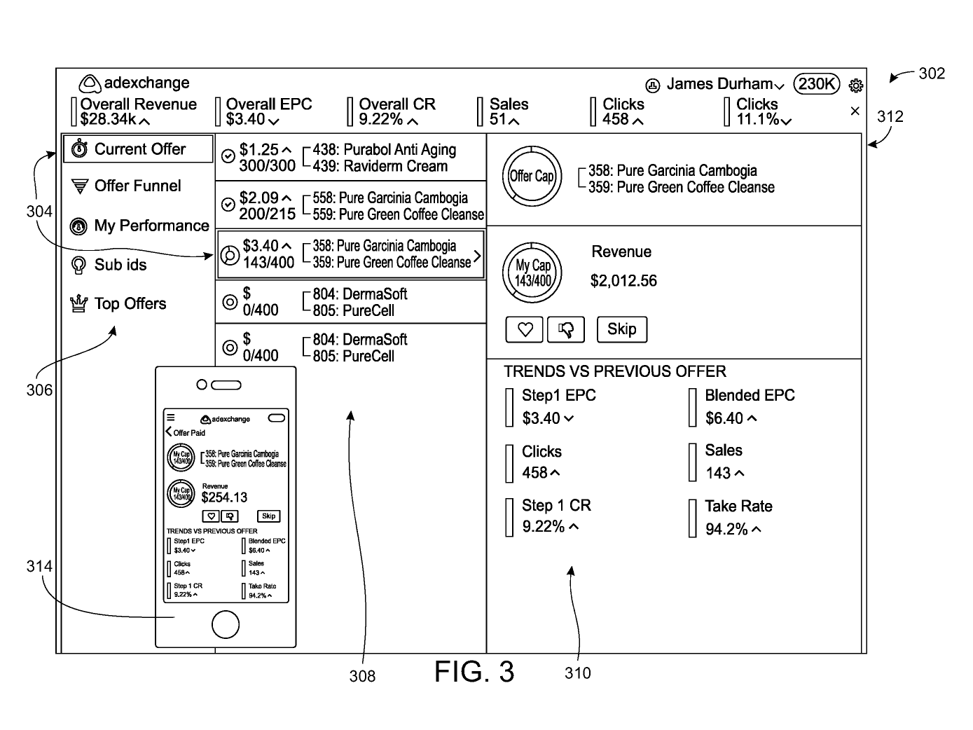

Referring now to FIG. 2, therein is shown a control flow for the SMART-funnel 108 of FIG. 1. The SMART-funnel 108 can be illustrated as a path of content presented to a consumer 202.

The SMART-funnel 108 can be depicted as the steps and the rules for how and when, components of the ad-exchange 102 of FIG. 1 are employed to complete the transactions for the consumer 202.

The consumer 202 can be directed toward the SMART-funnel 108 through affiliate web portals or websites including search engine websites, social media platforms, news aggregation websites, and networking websites. Similarly, the affiliates can be implemented as applications running on devices enabling the websites and portals listed.

The SMART-funnel 108 begin by initiating a product presentation step 204 in which the consumer 202 is presented with an offer from the advertiser. The offer can be created by an advertiser using selectable architecture, templates, tools, and widgets.

Illustratively, the offer of the product presentation step 204 can be implemented with reusable page types, reusable page components, and reusable multi-tenant and white-labeling components which can be selected by the advertiser. That is, the offer presented within the product presentation step 204 can be customized by the advertiser on the multi-tenant, white-label capable platform. The platform presents the advertiser with common and swappable templates and template components including: Hero headers, Headlines, Sub-headlines, Product Descriptions, Copies, Images, Videos, Badges, Forms, Calls to Action, Visual Cues, Terms & conditions, Payments, Shipping, Thank Yous, Up-sells, Add-ons, Add-on Types, Exits, Contact Information, Trust Indicators, Privacy Policies, Security Seals, Warranties, Social Proofs, Visual Deliverables, Assurances, Deliveries, Security, Loading widgets, Index pages, Qualifications, Reviews, Landing Pages, Sales Pages, Shopping Cart & Checkout pages, Page layouts, Versions, and Devices.

Based on the advertiser's selections and customizations of the components and pages listed above, an advertisement is shown to the consumer 202. If the consumer 202 continues past the first step by selecting a product or by further enquiring about the product the SMART-funnel 108 can initiate a collect contact information step 206.

The collect contact information step 206 can provide a request for the consumer's 202 contact information. The SMART-funnel 108 can further initiate a collect billing information step 208.

The collect billing information step 208 can provide a request for the consumer's 202 billing information. The SMART-funnel 108 can further initiate a cross-sell step 210.

The cross-sell step 210 can provide product offers for products in similar areas or offers for complimentary products. The SMART-funnel 108 can further initiate an up-sell step 212. The up-sell step 212 can provide offers or options to the consumer 202 to purchase upgrades to the product selected by the consumer 202 or to purchase a product package including the product selected by the consumer 202.

The SMART-funnel 108 can be communicatively coupled to third-party services 214. The third-party services 214 can include third-party payment gateways.

The third-party services 214 can further include sales tracking by third parties and customer relationship management by third parties. It is contemplated that the SMART-funnel 108 can collect sales information, information about the consumer 202, and can automate the order that the product presentation step 204, the collect contact information step 206, the collect billing information step 208, the cross-sell step 210, and the up-sell step 212 are presented to the consumer 202.

The information collected by the SMART-funnel 108 can alter the sequence in which the product presentation step 204, the collect contact information step 206, the collect billing information step 208, the cross-sell step 210, and the up-sell step 212 are presented to the consumer 202. The SMART-funnel 108 can further automatically determine which options are presented to the consumer.

The selection and determination of the SMART-funnel 108 can be based on offer duration, past performance of advertising campaigns, and/or by projected performance based on relative performance with peers. It is contemplated that the SMART-funnel 108 can track the key performance indicators including the number of consumer 202 that provide information during the collect contact information step 206 or the collect billing information step 208.

The SMART-funnel 108 can further track the key performance indicators including the number of times the consumer 202 cross-purchases during the cross-sell step 210 or up-purchases during the up-sell step 212. These key performance indicators tracked and recorded by the SMART-funnel 108 can be correlated and referenced with regard to the category or type of product and the category or type of the consumer 202 in order to determine which products, steps, or requests should be presented to the consumer 202 and in what order or time frame.

For example, the SMART-funnel 108 can automatically log the results of the SMART-funnel 108. Further it is contemplated that the SMART-funnel 108 can conducts split-testing, updates sales information for the purpose of adhering to sales caps created by the advertiser, provide any necessary systems administration and maintenance services, track information regarding consumer experience, relay orders to the advertiser, and track sales.

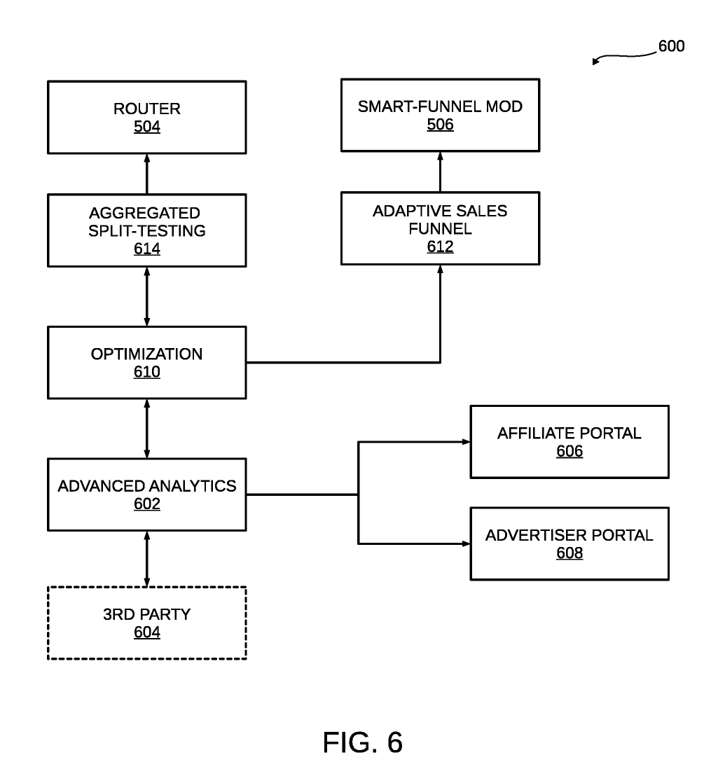

Referring now to FIG. 3, therein is shown a graphical display of an affiliate display 302 of the advertising system 100 of FIG. 1. The affiliate display 302 can include real-time visibility into traffic and offer performance to the affiliates, via the affiliate portal 606 of FIG. 6.

It is contemplated that the consumer management 500 can then match the consumer 202 traffic to offers and automatically rotate, sequence, and throttle traffic and sales caps. The results are displayed to the affiliates with the affiliate display 302.

As depicted, affiliate display 302 can include selections 304 from a first selectable column 306 and a second selectable column 308. The first selectable column 306 can include a current offer, offer funnel, my performance, sub ids, and top offers from which to select from.

As is shown my performance is currently selected as the selections 304. The second selectable column 308 can be a subset of the selectable options in the first selectable column 306. As can be seen the third selection is selected.

The content of the second selectable column 308 can be displayed in a content area 310. Above the content area 310, the second selectable column 308, and the first selectable column 306 is a header 312. The header 312 can include logo's important metrics and tickers, and login information. It is further contemplated that the information can be displayed as a mobile layout 314.

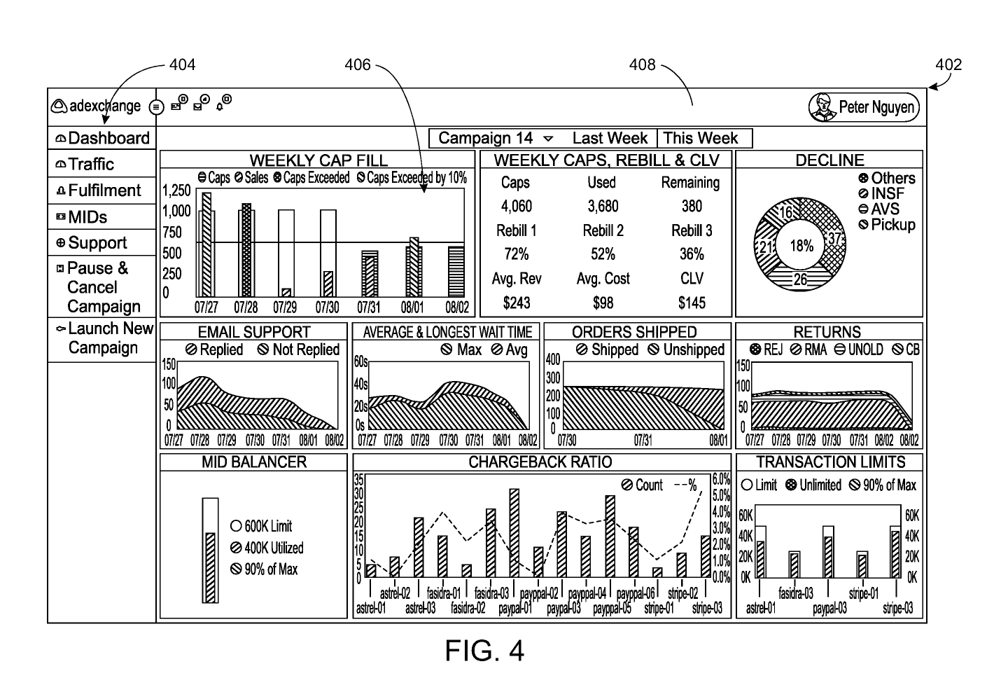

Referring now to FIG. 4, therein is shown a graphical display of an advertiser display 402 of the advertising system 100 of FIG. 1. As depicted the advertiser display 402 can be showing a dashboard for a specific advertising campaign and can be limited in time, for example current week or last week.

The advertiser display 402 can further provide full-stack campaign reporting for the advertiser, via the advertiser display 402. As shown, those reporting capabilities include conversion rate, earning per click, take rate, sales, cap statistics, inventory statistics, credit card declines, credit card approval rate, credit card vendor, credit card type, the re-bill rate, the fulfillment status as shipments and return status, call center key performance indicators including email support and call time, merchant account and transaction and chargeback status, customer lifetime cost in terms of revenue and value.

That reporting can be customize and reported on daily, weekly, quarterly and annual bases, and on a campaign-by-campaign basis. The earnings per click can be a blended earnings per click, which can include more than 1 product or offer.

It is contemplated that the consumer management 500 can then match the consumer 202 traffic to offers and automatically rotate, sequence, and throttle traffic and sales caps. The results are displayed to the advertisers with the advertiser display 402.

As will be appreciated the advertiser display 402 can include selections or selectable options 404, which can prompt the information within the dashboard or the advertiser portal 608 to be displayed in a content area 406. The advertiser display 402 can further include a header 408for user options and notifications.

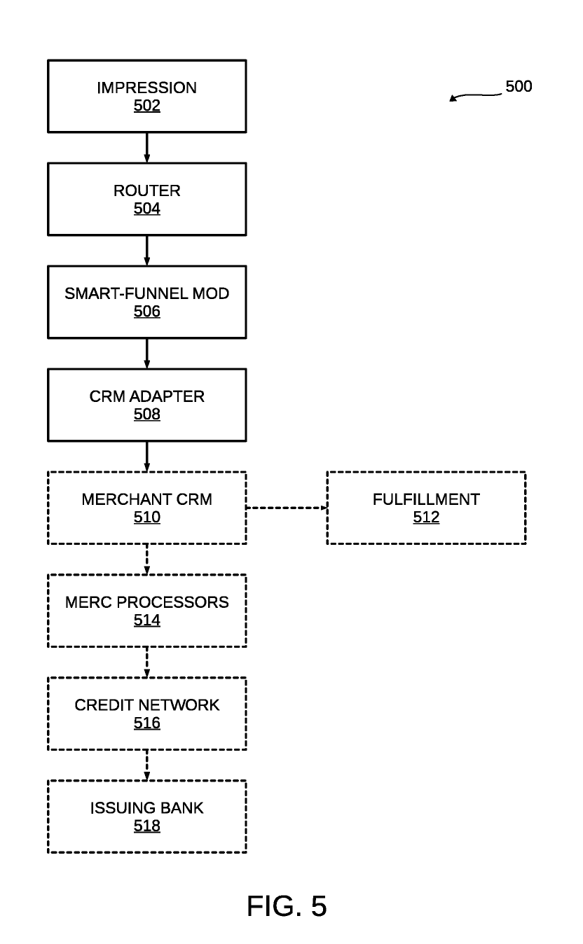

Referring now to FIG. 5, therein is shown a control flow of business to consumer management 500 for the advertising system 100 of FIG. 1. The consumer management 500 can begin with an ad impression module 502.

During the ad impression module 502, the consumer 202 of FIG. 2 can arrive at one of the affiliate pre-sale pages. The consumer 202 can view content on the affiliate page or can abandon the affiliate page.

If the consumer 202 views the content on the affiliate page, the consumer 202 can then select or click on an advertisement, a product image, a related image, a product description, or a clickable field for accessing more information. It is contemplated that the ad impression module 502 can collect information regarding the source of the traffic including the affiliate. The ad impression module 502 can further collect information regarding the demographics of the consumer 202, date-time of the engagement by the consumer 202, the device the consumer 202 is using, the user agent, the IP address, and the geolocation.

The information collected by the CAMP platform, the consumer's 202 device, the browser of the consumer's 202 device, a network interface, and an offer routing subsystem. The information collected within the ad impression module 502 can be stored and analyzed to influence decision making protocols on matching current consumer 202 traffic and future consumer 202 traffic with the most appropriate offers, offer sets, price points and offer flow.

The information collected within the ad impression module 502 can be stored in data stores, sales tracking systems, routing systems, and analytic modules. It is contemplated that a pre-sales page can be optionally implemented.

The pre-sales page can collect information similar to that collected by the ad impression module 502 from the consumer's 202 device, the consumer's 202 device browser, the network interface, the design or template variant id, and the initial or next available offer in offer set funnel. It is contemplated that within the optional pre-sales page the consumer 202 can be auto-routed or rotated to the next available offer.

Data and metadata can be stored and analyzed to influence decision making protocols on matching current consumer 202 traffic and future consumer 202 traffic with the most appropriate offers, offer sets, price points and offer flow. The optional pre-sales page can send the information collected to data stores, sales tracking systems, routing systems, customer relationship management systems, and analytic modules.

Once the ad impression module 502 has completed or the optional pre-sales page has completed, the consumer management 500 can initiate a router module 504. The router module 504 can route traffic and match the consumer's 202 traffic to offers based on the methods and modules described herein.

The router module 504 can utilize previously collected information about previous consumer 202 traffic and previous consumers 202 contained within data stores, the SITE-protect 112 of FIG. 1, the CAMPsites 104 of FIG. 1, the SMART-funnel 108 of FIG. 1, a routing module, a tracking module, an analytics module, an adaptive sales funnel module, a cap management module, or a marketplace optimization module.

The information used by the router module 504 can include conversion rates, post-sale consumer events, customer lifetime value scores, demographics, offer ratings, affiliate ratings, traffic ratings page designs, spit-test results, payment gateways, targets, goals, constraints, available caps to sellable units, blacklists, gray lists, and whitelists. Upon the completion of the router module 504 the consumer management 500 can initiate the SMART-funnel 108 in a SMART-funnel module 506.

The SMART-funnel module 506 can include the modules performed by the SMART-funnel 108 as described with regard to FIG. 2. To summarize, the SMART-funnel module 506 can provide information to the consumer 202 including long-form advertisements, advertising copy, audio material, and other multimedia presentations.

The content provided to the consumer 202 during the SMART-funnel module 506 can range from one or two seconds worth of content, to many minutes of content or longer. The content provided to the consumer 202 can either consist of a direct presentation, or it can include interactive components that seek information from the consumer 202, and the SMART-funnel module 506 can tailor the information provided to the consumer 202 based on the information obtained from the consumer 202.

Once the consumer 202 views the advertisement content, the consumer 202 is provided with the option of entering contact information. The provided contact information can include a physical address, an email address, a telephone number, or other contact information such as social media handles.

It is contemplated that once the consumer 202 enters contact information, the consumer 202 can be classified as a prospect. If the consumer 202 continues through the SMART-funnel 108 and enters payment information when prompted, the consumer 202 can then be classified as a customer. Payment information can include credit card information, bank account information, and links to third-party payment services.

The SMART-funnel module 506 can utilize information from the routing and tracking subsystem, the consumer's 202 device, the consumer's 202 device browser, a network interface, and an adaptive sales funnel subsystem. The information utilized by the SMART-funnel module 506 can include template variant ID, test variants, consumer 202 traffic provider, affiliate ID, design variant ID, template variant ID, offer ID, offer-set ID, product or service vertical, country of the consumer 202, and region of the consumer 202.

As discussed above with regard to FIG. 2, the information collected and utilized by the SMART-funnel module 506 can be used to provide an optimal offer selection for the individual consumer 202, optimal price point for the individual consumer 202, optimal page design for the individual consumer 202, and an optimal offer flow for the individual consumer 202.

Once the consumer 202 enters the contact information and the payment information during the SMART-funnel module 506, web and landing page analytics along with customer and order information are passed through a customer relationship management integration module. In particular, the customer and order information are relayed to chosen customer relationship manager, sales tracking, fulfillment and call center systems. The consumer management 500 can then match the consumer 202 traffic to offers and automatically rotate, sequence, and throttle traffic and sales caps.

Illustratively, a customer relationship management adapter module 508 can be invoked to register the consumer 202 as a prospect prior to the consumer 202 entering contact data, validate payments, place orders, and track post-sales events. To this end, the customer relationship management adapter module 508 can use order information, consumer 202 metadata, offer metadata, and traffic metadata from data stores, consumer 202 input, and from third party data enrichment systems.

Further a merchant customer relationship management module 510 can query application programming interfaces, event push application programming interfaces, perform data aggregations, and perform analytics. Information from the consumer 202 and the consumer's 202 order can be passed to the merchant customer relationship management module 510.

The information passed to the merchant customer relationship management module 510 can include order information, offer metadata, traffic metadata, and subscription analytics. It is contemplated that the information used within the merchant customer relationship management module 510 can be obtained from third-party customer relationship management, data stores, and analytic modules.

The order from the merchant customer relationship management module 510 can be passed to a fulfillment module 512 to complete the fulfillment of the order and shipment to the consumer 202.

Further the completion of the consumer's 202 order can include the processing of the payment information and contact information within a merchant bank payment processor module 514, a credit card network module 516, and a credit card issuing bank 518.

Referring now to FIG. 6, therein is shown a control flow of business intelligence 600 for the advertising system 100 of FIG. 1. The business intelligence 600 can include an advanced analytics module 602.

The advanced analytics module 602 can incorporate information and data from many sources. The advanced analytics module 602 can also provide output information and data.

Illustratively, the advanced analytics module 602 can aggregate in real time the key performance indicators, analyze historical key performance indicators, support decision making protocols to support testing, and perform new offer launching and auto-matching activities. The advanced analytics module 602 can utilize location information, language information, currency information, product vertical data, offer funnel offer-set, consumer 202 demographics, conversion rate, take rate, prices, subscription rate, re-bill rate, cancellation rate, refund rate, design template performance, offer performance, affiliate performance, traffic source performance, targets & goals, constraints, decision points & protocols, vendor performance, call center performance, fulfillment performance, chargeback management performance, manufacturing performance, blacklists, gray lists, whitelists, and ratings.

The information and data listed can be obtained from many sources including from third party modules 604. The third party modules 604 can be third party data enrichment systems.

For example, the advanced analytics module 602 can send and received data to the third party modules 604 for cleansing and enrichment of the data and information. The advanced analytics module 602 can further send information and data to an affiliate portal 606.

Illustratively, it is contemplated that the advanced analytics module 602 can provide information such as key performance indicators, earnings per click, and traffic quality indicators and data to the affiliate portal 606. The affiliate portal 606 can calculate and report sales performance and traffic quality then compare to others within the AEG network.

The affiliate portal 606 can also auto-route offers and auto-skip offers based on business rules and targets. The affiliate portal 606 can utilize data from the SMART-funnel 108, sales data, traffic source data, page design data, key performance indicators sent from the advanced analytics module 602.

The advanced analytics module 602 can still further send information and data to an advertiser portal 608. Illustratively, it is contemplated that the advanced analytics module 602 can provide information such as advertising campaign key performance indicators, and consumer lifetime values to the advertiser portal 608.

The advertiser portal 608 can calculate and report advertising campaign key performance indicators, risk scores, and trends. The advertiser portal 608 can utilize units sold, unit sale caps, credit card transaction data, fulfillment data, inventory data, advertising campaign data, delivery data, customer support data, traffic performance, chargeback, and merchant account data.

The advanced analytics module 602 can still further exchange information and data with a marketplace exchange optimization module 610. The marketplace exchange optimization module 610 can provide a manual rating system, a vendor rating system, and analyze customer lifetime experience.

It is contemplated that the marketplace exchange optimization module 610 can utilize full stack offer performance, payment gateway data, fulfillment data, call center data, terms & conditions data, privacy policy data, offer content data, traffic provider rating data, traffic source data, pre-sale page content, ad placement quality, and demographic targeting. The marketplace exchange optimization module 610 can further utilize consumer 202 locale, consumer 202 language, consumer 202 currency, consumer 202 region, consumer 202 state, product vertical, offer funnel, offer-set, consumer 202 demographics, conversion rate, take rate, prices, subscription rate, re-bill rate, cancellation rate, refund rate, design template performance, targets & goals, constraints, decision points & protocols, vendor performance, call center performance, fulfillment performance, chargeback management, marketplace governance, blacklists, gray lists, whitelists, ratings, and customer lifetime value.

As will be appreciated, the marketplace exchange optimization module 610 can be communicatively coupled to an adaptive sales funnel module 612. The adaptive sales funnel module 612 can analyze the consumer 202 demographics, user data, select targeted assets, and render assets in the SMART-funnel 108.

The adaptive sales funnel module 612 can output this data and provide feedback to the SMART-funnel module 506. The marketplace exchange optimization module 610 can further be communicatively coupled to an aggregated split-testing module 614.

The marketplace exchange optimization module 610 can output and receive communications, data, or information from the aggregated split-testing module 614. The aggregated split-testing module 614 can collect and aggregate split testing or multivariate testing from multiple advertising campaigns for conversion rate optimization. The results of the aggregated split-testing module 614 can be output or fed into the router module 504 and the marketplace exchange optimization module 610.

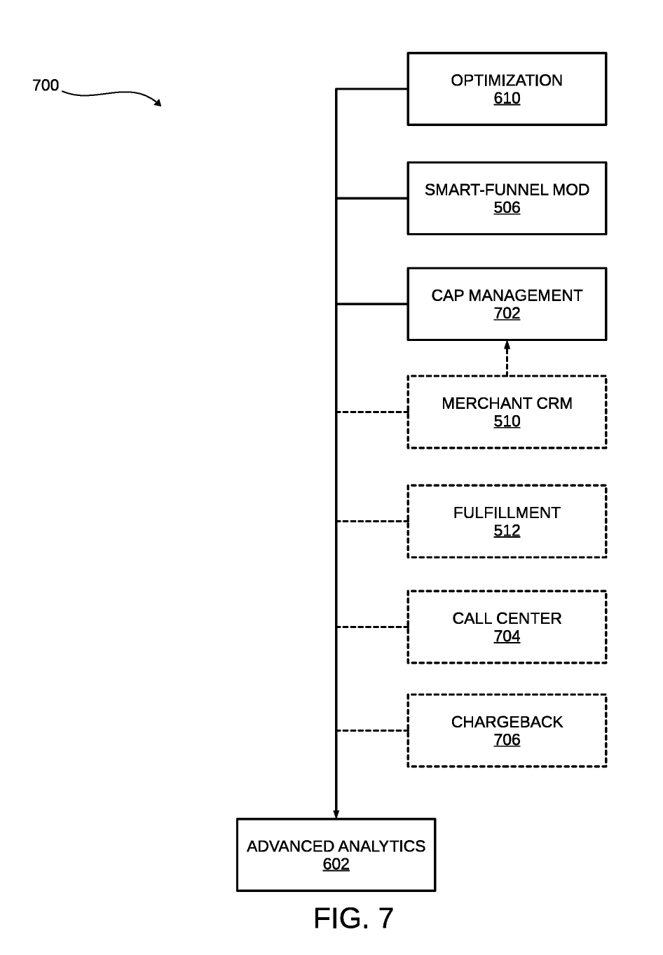

Referring now to FIG. 7, therein is shown a control flow of feedback 700 for the advertising system 100 of FIG. 1. The feedback 700 is shown flowing from many sources into the advanced analytics module 602.

Illustratively, the marketplace exchange optimization module 610, the SMART-funnel module 506, the merchant customer relationship management module 510, and the fulfillment module 512 can output feed back into the advanced analytics module 602 and provide the advanced analytics module 602 with the information and data described above.

The SMART-funnel module 506 can output web analytics and key performance indicators to the advanced analytics module 602. The marketplace exchange optimization module 610 can provide or output key performance indicators and ratings to the advanced analytics module 602.

The merchant customer relationship management module 510 can output offer data to a cap management module 702. The cap management module 702 can process the offer data and output feed back in the form of offer key performance indicators to the advanced analytics module 602.

The merchant customer relationship management module 510 and the fulfillment module 512 along with a call center module 704 and a chargeback management module 706 can provide post sale data, post sale event data, and key performance indicators to the advanced analytics module 602.

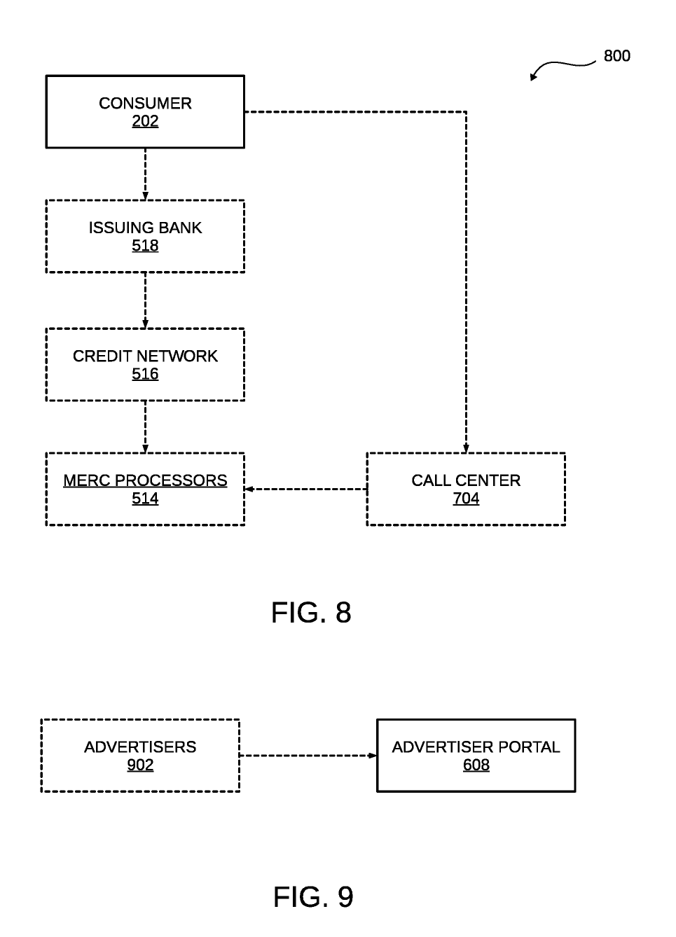

Referring now to FIG. 8, therein is shown a control flow of customer feedback 800 for the advertising system 100 of FIG. 1. The customer feedback 800 can depict a control flow for a charge back from the consumer 202 or for a cancellation of a trial offer or for a refund of a product.

It is contemplated that when the consumer 202 initiates a charge back, the chargeback request flow from the consumer 202 to the credit card issuing bank 518, to the credit card network module 516, and finally to the merchant bank payment processor module 514. In a similar way when the consumer 202 initiates a cancellation of a trial offer or a refund on a product, the consumer 202 can contact the call center module 704 and the call center module 704 can request an adjustment or reversal of charges at the merchant bank payment processor module 514.

Referring now to FIG. 9, therein is shown a control flow for the advertiser portal 608 of FIG. 6. The advertiser portal 608 is depicted as an interface for advertisers 902. The advertiser portal 608 can, for example, be the advertiser portal 608 including the advertiser display 402 of FIG. 4.

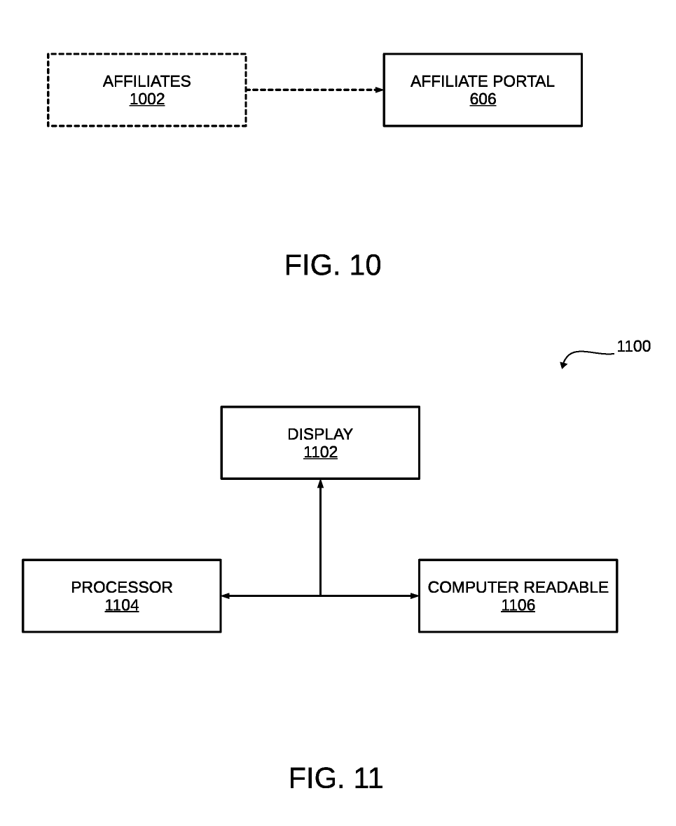

Referring now to FIG. 10, therein is shown a control flow for the affiliate portal 606 of FIG. 6. The affiliate portal 606 is depicted as an interface for affiliates 1002. The affiliate portal 606 can, for example, be the affiliate portal 606 including the affiliate display 302 of FIG. 3.

Referring now to FIG. 11, therein is shown a block diagram for a distributed system 1100 for the advertising system 100 of FIG. 1. The distributed system 1100 is depicted having a displays 1102, processors 1104, and non-transitory computer readable media 1106.

It is contemplated that the displays 1102, the processors 1104, and the non-transitory computer readable media 1106 can be communicatively coupled. It is further contemplated that the processors 1104 and the non-transitory computer readable media 1106 could be integrated in one machine or distributed across multiple machines and connected via a local area network or through the internet.

The distributed system 1100 can enable the business to consumer management 500, the business intelligence 600, and the feedback 700. Illustratively the information and data for the ad impression module 502, the router module 504, the SMART-funnel module 506, the customer relationship management adapter module 508, the merchant customer relationship management module 510, the fulfillment module 512, the merchant bank payment processor module 514, the credit card network module 516, and the credit card issuing bank 518 can be stored on the non-transitory computer readable media 1106.

The steps, rules, and processes of the ad impression module 502, the router module 504, the SMART-funnel module 506, the customer relationship management adapter module 508, the merchant customer relationship management module 510, the fulfillment module 512, the merchant bank payment processor module 514, the credit card network module 516, and the credit card issuing bank 518 can be stored as instructions on the non-transitory computer readable media 1106 and can be performed using the processors 1104.

Illustratively the information and data for the advanced analytics module 602, the third party modules 604, the affiliate portal 606, the advertiser portal 608, the marketplace exchange optimization module 610, the adaptive sales funnel module 612, and the aggregated split-testing module 614 can be stored on the non-transitory computer readable media 1106.

The steps, rules, and processes of the advanced analytics module 602, the third party modules 604, the affiliate portal 606, the advertiser portal 608, the marketplace exchange optimization module 610, the adaptive sales funnel module 612, and the aggregated split-testing module 614 can be stored as instructions on the non-transitory computer readable media 1106 and can be performed using the processors 1104.

Illustratively the information and data for the cap management module 702, the call center module 704, and the chargeback management module 706 can be stored on the non-transitory computer readable media 1106. The steps, rules, and processes of the cap management module 702, the call center module 704, and the chargeback management module 706 can be stored as instructions on the non-transitory computer readable media 1106 and can be performed using the processors 1104.

Thus, it has been discovered that the advertising system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the advertising system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

Specifically the advertising system 100 can provide many non-abstract improvements to the underlying technology supporting the advertising system 100 including reduced load on the processors 1104 of FIG. 11, reduced memory requirements of the non-transitory computer readable media 1106 of FIG. 11, and reduced communication bandwidth requirements of communication networks coupling the displays 1102 of FIG. 11, the processors 1104, and the non-transitory computer readable media 1106.

That is, the advertising system 100 eliminates the delays inherent in existing systems, and provides added benefits to the advertisers by providing a fully automated Software- as-a-Service (“SaaS”) solution. One contemplated embodiment of the advertising system 100 can significantly speed up time-to-market, by testing and scaling direct response advertising campaigns.

It has been discovered that employment of the advertising system 100 of template driven, test data driven and winning ad designs maximizes the success of any given advertising campaign. As discussed the advertising system 100 can provide a multi-tenant solution, which reduces costs for the advertiser, while maintaining flexible and secure solutions, tailored to the advertiser. The multi-tenant solution allows advertisers to use the product without the need of sophisticated internal or leased information technology infrastructure.

Yet another advantage of the advertising system 100 results from the white-labeling capabilities discussed above. The white-labeling reduces cost to the advertiser, while still allowing the advertiser to create customized advertisements. The multi-tenant and white-labeling capabilities can be provided on a common server and delivery infrastructure to further reduce costs and improve ease of use.

Still further the white-labeling capabilities allow the advertiser to customize their company and domain name, the product names, the type of media used in the advertisement, the ad copy, the terms and conditions, and disclaimers. The advertising system's 100 reporting and analytic capabilities provide centralized and the ground truth for all campaign data and resulting performance key performance indicators such as attribution, conversion, take-rate, traffic quality, ratings for network actors, among others.

Yet another recognized advantage of the advertising system 100 is that it has the advantage of providing integrated and automated split-testing, which eliminates the need for manual ad campaign testing and optimization. The advertising system 100 further allows advertisers to institute an automated cap on sellable units, which avoids manual efforts from affiliates, publishers, advertisers and networks/marketplaces to track and maintain allowable sales transactions.

The disclosed automated cap management includes automatic cutoff and restoration of allowable traffic and/or sales as appropriate in the daily and weekly context. Still another advantage of the advertising system 100 is that it automates traffic management, including whitelisting and blacklisting affiliate traffic from affiliate and/or bad actors from certain offers, assigning daily and weekly sales amounts to affiliate traffic and automatically employing a cutoff and re-store traffic as appropriate and within daily and weekly context of the offers in the offer funnel.

Another advantage of the advertising system 100 is that it allows advertisers to customize long-form advertising solutions. The advertising system 100 allows advertisers to create long-form advertisements that range from a few seconds to multiple minutes or longer. This solution provides web analytics and consumer behavioral intelligence as part of the sales funnel analysis to continuously test and optimize the offer ad pages for better performance.

A further advantage of the advertising system 100 is automated offer flow funneling, which further reduces the need for a complex IT infrastructure within the client company and reduces the need for multi-layer internal decision making. Yet another advantage of the advertising system 100 results from the combination of elements described allowing and enabling advertisers and the network to protect their design intellectual property and prevent competitors or affiliates from misappropriating advertising content and investment.

Intellectual property protection, called SiteProtect, prevents competitors from copying advertising content and/or templates. The SiteProtect feature monitors user interactions as advertising content is accessed. When user interactions represent unsanctioned activities such as ad copying activities, the user will be presented with stale, un-optimized pages, special message or with nothing at all. To add further protection, the URL address of the advertisement is non-sharable and may be scrambled.

The it has been discovered that the advertising system 100 can eliminate the delays inherent in existing systems, and provides added benefits to the advertisers by providing a fully automated Software-as-a-Service (“SaaS”) solution. One embodiment of the advertising system 100 can allow and enable advertisers to significantly speed up time-to-market, by testing and scaling direct response advertising campaigns. The disclosed advertising system 100 employs white-labeling capabilities, reusable page and component templates, reliable test data and proven best-in-the-wild ad designs in order to maximize the success of any given advertising campaign and participating media buying affiliates.

The advertising system 100 can provide actionable intelligence, guidance parameters and algorithms for network/marketplace optimization, auto-matching traffic to offers, preventing traffic to offer caps/inventory imbalances, maximizing margins for all players in a performance-driven environment that is also balanced between near-term and long-term goals. Furthermore, demographic, behavioral intelligence and other attribution data will be leveraged and shared across the entire network/marketplace and extended ecosystem to better target or re-target consumers and matching them with better performing offer ads.

Specifically, it has been discovered that the automated direct response advertising system including: collecting information of a consumer including information of an affiliate source of the consumer, demographics of the consumer, date and time of engagement by the consumer, information of a device used by the consumer, an IP address for the consumer, and geolocation of the consumer; routing and matching the consumer to an offer of a product based conversion rates, post-sale consumer events, customer lifetime value scores, demographics, offer ratings, affiliate ratings, traffic ratings page designs, spit-test results, payment gateways, targets, goals, constraints, available caps to sellable units, blacklists, gray lists, and whitelists; providing content to the consumer with a reusable page, reusable page components, reusable multi-tenant components, and white-labeling components; requesting contact information from the consumer; requesting billing information from the consumer; providing a cross-sell offer for complimentary products of the product; providing an up-sell offer for upgrades to the product; aggregating information including: a conversion rate, a take rate, prices, a subscription rate, a re-bill rate, a cancellation rate, a refund rate, design template performance, offer performance, affiliate performance, traffic source performance, blacklists, gray lists, and whitelists within an advanced analytics module; and displaying the information from the advanced analytics module on a display can provide non-abstract technological improvements including reduced memory, processing, and communication requirements based on these specific steps, rules and resulting data structures. Further these steps, rules, and resulting data structures can enable the performance of automated direct response advertising not previously within the capabilities of computer systems and using the steps, rules, and data structures not known to be used by humans.

What is claimed is:

1. An automated direct response advertising method comprising:
collecting information of a consumer including information of an affiliate source of the consumer, demographics of the consumer, date and time of engagement by the consumer, information of a device used by the consumer, an IP address for the consumer, and geolocation of the consumer;
routing and matching the consumer to an offer of a product based conversion rates, post-sale consumer events, customer lifetime value scores, demographics, offer ratings, affiliate ratings, traffic ratings page designs, spit-test results, payment gateways, targets, goals, constraints, available caps to sellable units, blacklists, gray lists, and whitelists;
providing content to the consumer with a reusable page, reusable page components, reusable multi-tenant components, and white-labeling components;
requesting contact information from the consumer;
requesting billing information from the consumer;
providing a cross-sell offer for complimentary products of the product;
providing an up-sell offer for upgrades to the product;
aggregating information including: a conversion rate, a take rate, prices, a subscription rate, a re-bill rate, a cancellation rate, a refund rate, design template performance, offer performance, affiliate performance, traffic source performance, blacklists, gray lists, and whitelists within an advanced analytics module; and
displaying the information from the advanced analytics module on a display.

2. The method of claim 1 further comprising conducting split-testing and updating sales information for adhering to sales caps created by an advertiser.

3. The method of claim 1 further comprising monitoring advertising campaign traffic for malicious indicators.

4. The method of claim 3 further comprising blocking malicious traffic in real-time.

5. The method of claim 1 further comprising providing a full-stack campaign reporting for an advertiser including the conversion rates, earning per click, take rate, cap statistics, inventory statistics, credit card declines, credit card approval rate, credit card vendor, credit card type, the re-bill rate.

6. The method of claim 1 wherein routing and matching the consumer to the offer includes routing and matching the consumer to the offer created by an advertiser using selectable architecture, selectable templates, selectable tools, and selectable widgets.

7. The method of claim 1 further comprising accessing third-party payment gateways to complete a transaction of the consumer.

8. A non-transitory computer readable medium in useful cooperation with a processor including instructions configured to:
collect information of a consumer including information of an affiliate source of the consumer, demographics of the consumer, date and time of engagement by the consumer, information of a device used by the consumer, an IP address for the consumer, and geolocation of the consumer;
route and match the consumer to an offer of a product based conversion rates, post-sale consumer events, customer lifetime value scores, demographics, offer ratings, affiliate ratings, traffic ratings page designs, spit-test results, payment gateways, targets, goals, constraints, available caps to sellable units, blacklists, gray lists, and whitelists;
provide content to the consumer with a reusable page, reusable page components, reusable multi-tenant components, and white-labeling components;
request contact information from the consumer;
request billing information from the consumer;
provide a cross-sell offer for complimentary products of the product;
provide an up-sell offer for upgrades to the product;
aggregate information including: a conversion rate, a take rate, prices, a subscription rate, a re-bill rate, a cancellation rate, a refund rate, design template performance, offer performance, affiliate performance, traffic source performance, blacklists, gray lists, and whitelists within an advanced analytics module; and
display the information from the advanced analytics module on a display.

9. The computer readable media of claim 8 further comprising instructions configured to conduct split-testing and update sales information for adhering to sales caps created by an advertiser.

10. The computer readable media of claim 8 further comprising instructions configured to monitor advertising campaign traffic for malicious indicators.

11. The computer readable media of claim 10 further comprising instructions configured to block malicious traffic in real-time.

12. The computer readable media of claim 8 further comprising instructions configured to provide a full-stack campaign reporting for an advertiser including the conversion rates, earning per click, take rate, cap statistics, inventory statistics, credit card declines, credit card approval rate, credit card vendor, credit card type, the re-bill rate.

13. The computer readable media of claim 8 wherein the instructions configured to route and match include instructions configured to route and match the consumer to the offer created by an advertiser using selectable architecture, selectable templates, selectable tools, and selectable widgets.

14. The computer readable media of claim 8 further comprising instructions configured to access third-party payment gateways to complete a transaction of the consumer.

15. An automated direct response advertising system comprising:
a processor configured to:
collect information of a consumer including information of an affiliate source of the consumer, demographics of the consumer, date and time of engagement by the consumer, information of a device used by the consumer, an IP address for the consumer, and geolocation of the consumer,
route and match the consumer to an offer of a product based conversion rates, post-sale consumer events, customer lifetime value scores, demographics, offer ratings, affiliate ratings, traffic ratings page designs, spit-test results, payment gateways, targets, goals, constraints, available caps to sellable units, blacklists, gray lists, and whitelists,
request contact information from the consumer,
request billing information from the consumer,
aggregate information including: a conversion rate, a take rate, prices, a subscription rate, a re-bill rate, a cancellation rate, a refund rate, design template performance, offer performance, affiliate performance, traffic source performance, blacklists, gray lists, and whitelists within an advanced analytics module; and
a display configured to:
display content to the consumer with a reusable page, reusable page components, reusable multi-tenant components, and white-labeling components,
display a cross-sell offer for complimentary products of the product,
display an up-sell offer for upgrades to the product, and
display the information from the advanced analytics module on a display.

16. The system of claim 15 wherein the processor is further configured to conduct split-testing and update sales information for adhering to sales caps created by an advertiser.

17. The system of claim 15 wherein the processor is further configured to monitor advertising campaign traffic for malicious indicators, and to block malicious traffic in real-time.

18. The system of claim 15 wherein the display is further configured display a full-stack campaign reporting for an advertiser including the conversion rates, earning per click, take rate, cap statistics, inventory statistics, credit card declines, credit card approval rate, credit card vendor, credit card type, the re-bill rate.

19. The system of claim 15 wherein the processor is further configured to route and match the consumer to the offer created by an advertiser using selectable architecture, selectable templates, selectable tools, and selectable widgets.

20. The system of claim 15 wherein the processor is further configured to access third-party payment gateways to complete a transaction of the consumer.
